(19) United States
(12) Patent Application Publication
(10) Pub. No.: US 2012/0237554 A1
(43) Pub. Date: Sep. 20, 2012

(54) MICROBIAL CONTROL OF AETHINA TUMIDA WITH METARHIZUM ANISOPLIAE

(75) Inventor: Lambert Houssou Ble KANGA, Tallahassee, FL (US)

(73) Assignee: FLORIDA A & M UNIVERSITY

(21) Appl. No.: 13/048,557

(22) Filed: Mar. 15, 2011

(51) Int. Cl. A01N 63/04; A01P 7/04; A01N 25/08

(52) U.S. Cl. 424/400; 424/93.5

(57) ABSTRACT

The fungus Metarhizum anisopliae and the fungus Beauveria bassiana have been found to be effective for control of small hive beetles in honey bee colonies. The control of small hive beetles in honey bee colonies is effected by applying to the beetle, the honey bee hive, the vicinity of the honey bee hive, or the surrounding soils, or the soil in the pan at the hive bottom board, a composition of a miticidally effective amount of Metarhizum anisopliae or Beauveria bassiana.

### BACKGROUND OF THE INVENTION

1. Field of the Invention

The invention relates to a method of controlling the small hive beetle, a very destructive and invasive pest of honey bees using Metarhizum anisopliae or Beauveria bassiana.

2. Description of the Prior Art

Honey bees are economically important not only for honey production, but also for crop pollination. More than 400 agricultural crops worldwide are pollinated by honey bees.

Pollen, honey products, and bee venom are important in health food and alternative medicine. From an economic stand point, the value of crops that require pollination by honey bees in the United States is estimated at nearly $24 billion each year and the added value to U.S. crops from honey bee pollination at $19 billion. Presently, small hive beetle, Aethina tumida is a serious threat to honey bee populations and US agriculture. This destructive pest has rapidly spread into more than 30 other states since its introduction in Florida in 1998 (Elzen et al. 1999. Status of the small hive beetle in the U.S., Bee Culture 127, 28-29). The substantial damage of the small hive beetle is caused mainly by the feeding of larvae on honey, pollen, and live brood. They also tunnel and pierce wax combs; defecate in and ferment stored honey causing it to weep and froth away from the cells (Sanford, 1999. Aethina tumida. a new bee hive pest in the Western hemisphere, Apis 16, 1-5). As a result, there is a substantial reduction of all feral and managed honey bee populations and this situation threatens honey production, as well as the crops that rely on honey bees for pollination.

Currently, adult small hive beetles are being controlled by the use of the plastic strips comprising organophosphate Coumaphos. However, this chemical was reported to leave residues in honey products, was harmful to the bees, and failed to provide extended control of the pest (Elzen et al. 1999. Status of the small hive beetle in the U.S., Bee Culture 127, 28-29).

### SUMMARY OF THE INVENTION

It has been found that the fungus Metarhizum anisopliae and the fungus Beauveria bassiana are both effective for control of small hive beetle in populations of honey bees.

Accordingly, the present invention provides a method of controlling small hive beetles in populations of honey bees which comprises contacting said beetles with a composition comprising Metarhizum anisopliae.

The present invention also provides a method of controlling small hive beetles in populations of honey bees which comprises contacting said beetles with a composition comprising Beauveria bassiana.

The control of small hive beetle in populations of honey bees can be effected by both topical praying of adult and larvae of small hive beetle with the fungal spores, by setting up bait stations inside the bee hive and by soil drench to control larvae of small hive beetle prior to adult emergence.

The present invention provides a method that does not significantly harm honey bees subjected to treatments and that does not leave pesticidal residues in honey or wax; and therefore the honey or wax is safe for human consumption.

### BRIEF DESCRIPTION OF THE DRAWINGS

FIG. 1 is a Mycelia of Metarhizium anisopliae emerged from small hive beetles 14 days after treatment. The SHB were surfaced-sterilized and placed in agar medium to investigate the recovery of the fungus.

FIG. 2 is a Mycelia of Beauveria bassiana emerged from small hive beetles 14 days after treatment. The SHB were surfaced-sterilized and placed in agar medium to investigate the recovery of the fungus.

### DETAILED DESCRIPTION OF THE INVENTION

Both the fungus Metarhizum anisopliae and the fungus Beauveria bassiana are effective for controlling small hive beetle.

The methods of the present invention may be used for protecting a variety of honey bee species from small hive beetle infestations, particularly Apis mellifera L., as well as related honey bees such as A. cerana, A. dorsata, and A. florea.

Upon contact with the exterior surface of a beetle (larvae, pupae, and adults), the conidia or spores of the fungus germinate and invade the beetle by penetration through the cuticle. The beetle host is killed as the fungus grows therein. Additional spores are subsequently produced in the infected beetle host. The source of the Metarhizum anisopliae and the Beauveria bassiana strains may be a variety of strains obtained from different sources and are preferably naturally occurring strains and purified isolates.

The fungi may be cultivated by conventional techniques under any convenient aerobic conditions that are effective to promote growth. In accordance with the preferred embodiment, the fungi are inoculated and grown on conventional solid-phase mycology culture media. Several culture media may be employed, including rice, nutrient agar, tryptic soy agar, potato-dextrose agar, or a reduced nutrient agar. The fungi will grow over wide temperature and pH ranges, generally between about 10° to 38° C. and a pH of about 6.5 to 7.5, respectively, with temperature between about 25 to 35° C. and a pH of about neutral being optimal. Once a sufficiently heavy growth of the fungus has been obtained, usually in about 5 to 10 days, spores may be recovered, for example, by scraping the colonies with a brush or bladed instrument such as a spatula or scalpel. When harvested in this manner, the conidia readily break from the hyphae, adhering to the scraping instrument. Harvested spores may be stored in a dry environment, frozen or lyophilized, or they may be dispersed in a suitable carrier such as water or buffer, until used.

For large scale production of spores, the fungi may first be grown by culture in liquid media to obtain increased quantities of mycelia, which may subsequently be used as an inoculum onto the above-mentioned solid media for spore production. Conventional techniques for such liquid culture are suitable for use herein. Preferred liquid media include nutrient broth, sabouraud dextrose soy broth, and potato-dextrose broth. When grown in large scale vessels, the culture media should also be agitated and aerated for optimal growth. The mycelia may be easily harvested after incubation using conventional techniques, such as by settling, filtration, or centrifugation, and subsequently inoculated onto the solid, spore-producing media as described herein above.

Commercial formulations containing the fungi may be prepared from spores which have been harvested from the culture media such as described herein above. In the preferred embodiment, spores may be harvested and formulated with solid inert carriers such as talc, clay, or vermiculite, or incorporated into conventional controlled release micro particles or microcapsules. Suitable carriers for encapsulation include but are not limited to alginate gels, wheat-gluten matrices, starch matrices, or synthetic polymers as are known in the art. Further still, the fungi may be incorporated into waxes or protective coatings such as described by Nisperos-Carriedo and Baldwin (U.S. Pat. No. 5,198,254, the contents of which are incorporated by reference herein). In yet another embodiment, the spores may be impregnated or coated onto strips of material such as paper, plastic, cloth or other textile or fabric. Spores of the fungus may also be formulated as a suspension or emulsion in a suitable agronomically acceptable inert liquid carrier or vehicle.

Liquid carriers include but are not limited to water, buffers, or vegetable or plant oils.

The skilled practitioner will recognize that the fungi may be formulated in combination with conventional additives such as emulsifying agents, surfactants or wetting agents, antioxidants, colorants or dyes, or other insecticides.

The amount of the fungal spores and their concentration in the final composition are selected to provide an effective pesticidal control of the target beetles in a population of honey bees. A pesticidally effective amount is defined herein as that quantity of spores that result in a significant increase in the mortality rate of beetles treated with the fungus (treated either directly by soil treatments or indirectly through treated honey bee populations), relative to an untreated control. Actual amounts and concentrations may be readily determined by routine testing, and may vary considerably depending upon the mode of application, formulation, the size of the hive, and environmental conditions, particularly temperature and humidity. Without being limited thereto, in soil drench (to the locus or the vicinity of the hive) for conventional Langstroth hives (which are commonly used by most bee keepers), soils mixed with suspensions of fungal spores inside a pan and placed inside the hive as a bottom board of the bee hive, treated with spore suspensions, it is envisioned that an amount ranging from 10⁶ to 10⁹ spores/ml of Metarhizum anisopliae or Beauveria bassiana will be effective.

Further one ml of fungal suspensions for approximately 20 g of soils will effectively infect the target pest in soil drench. In the preferred embodiment, the amount of spores may be adjusted accordingly.

To be effective, the fungal spores must come into contact with the beetle (larvae, pupae, adults); therefore, the spores may be applied directly to the target beetles (to the locus or the vicinity of the hive to be protected). Without being limited thereto, application may be effected, for example, by spraying, dusting, atomizing, or dropping the composition of the fungal spores in or in the vicinity of the hive. Compositions formulated with an above-mentioned feeding supplement may be placed in or in the vicinity of the hive whereupon the small hive beetle will contact the spores by feeding. Alternatively, the liquid or solid phase compositions may be placed in or adjacent to the hive where small hive beetles are physically in contact with as they enter and/or leave the hive, or strips coated or impregnated with the spores may be placed or hung in the hives. However, in the preferred embodiment, the spores will typically be applied to the hives by dusting or using the above mentioned coated strips or by bait stations placed inside the bee hive. It has been found that the germination of the spores, and hence their pesticidal efficacy, is significantly greater under substantially the same warm and humid conditions as are typically found in the honey bee brood (approximately 30-35° C. and 85-95% relative humidity). Thus, the process of this invention is well-suited to the control of small hive beetles in honey bee populations.

Furthermore Butt et al. [1998. Honey-bee-mediated infection of pollen beetle (Meligethes aeneus Fab.) by the insect-pathogenic fungus, Metarhizium anisopliae. Biocontrol Sd Technol. 8, 533-538] reported that bees are effective agents for the dissemination of Metarhizum anisopliae to control pollen beetles on oilseed rape without any adverse effect on honey bee colonies. This invention shows that Aethina tumida is a new and suitable host for these entomopathogenic hyphomycetes. Unlike bacteria and viruses, these fungi do not have to be ingested to cause infection but penetrates the host cuticle directly, making it an improved microbial control agent of this parasite (small hive beetle).

The following examples are intended only to further illustrate the invention and are not intended to limit the scope of the invention.

### Example 1

The infectivity of Metarhizum anisopliae against Aethina tumida. The small hive beetles used in bioassays were collected from infested hives from honey bee colonies maintained at the apiary at FAMU Research Farm, Quincy, Fla., and at Rish Tupelo Apiary Wewahitchkam, Fla. The Metarhizum anisopliae strain was recovered from diseased small hive beetles collected in the field and cultured on fungal media after surface sterilization. The fungal isolate was identified and subcultured in Petri dishes on Sabouraud maltose agar (Difco, Detroit, Mich.) supplemented with 1% yeast (SMAY), and incubated at 27±1° C., 85% relative humidity, and 13:11 (Light:Dark) h photoperiod. Conidia from 14-19 day-old cultures were harvested with 0.1% Triton X-100, washed once in deionized water by centrifugation at 5,000 rpm for 20 min to concentrate the spores. They were then diluted in distilled water to produce fungal suspensions ranging from 10⁴ to 10¹¹ per ml for bioassays. Twenty to thirty small hive beetles were transferred to glass Petri plates containing a wet Whatman filter paper (Whatman International Ltd, Maidstone, England) and sprayed with 1-ml of conidial suspensions using a Potter Precision Spray Tower (Burkhard Manufacturing, Rickmansworth, England) with 0.7 kg·cm² pressure and a 0.25 mm orifice diameter nozzle.

Small hive beetles treated with distilled water only served as controls. Three treated small hive beetle were then transferred to each SOLO (2 mm depth, ¾ filled) laboratory bioassay cup (BIO-SERV, Urbana, Ill.) containing pollen dough substitutes as a food source. Mortality data were compiled and subjected to Probit analysis to generate dose mortality regression lines.

Dead small hive beetles were collected after treatments and surface-sterilized with Exspor (Alcide Corp., Redmond, Wash.) and 95% ethanol, then placed on water-agar to assess the recovery of the fungus. The agar plates were incubated at 25° C. for 5-10 days, and only beetles that showed fungal growth were considered to have died from infection and used in data analysis.

Metarhizum anisopliae was pathogenic to small hive beetle at temperatures similar to that maintained by honey bees in a colony. Lethal concentration for 50% cumulative mortality of beetles (LC₅₀) was 8.4×10⁷ conidia ml⁻¹ for larvae and 0.1×10⁷ conidia ml⁻¹ for adults. (Table 1).

### Example 2

The efficacy of Metarhizum anisopliae was determined in drench soil bioassays against larvae and pupae small hive beetles using similar bioassay techniques as described in Example 1.

Sterilized soil samples (20 g) were placed inside the SOLO laboratory cups. The soil samples were sprinkled with 2 ml of water; covered and allowed to settle for approximately 30 minutes under a fume cupboard. One ml of each concentration of the fungal spores in triton was then pipetted into each treatment cup. After the fungus was added to the soil, four instar larvae of small hive beetle were transferred into each cup. Deionized water containing 0.02% Silwet L-77 was used as controls for each experiment run. Five concentrations: 10⁴, 10⁵, 10⁶, 10⁷, and 10⁸ conidia per ml were tested and each treatment was replicated three times. The treated beetles were held in an incubator [27±1° C., 85% relative humidity, and 13:11 (Light:Dark) h photoperiod]. Beetle mortality was recorded daily for 21 days.

Mortality data were compiled and subjected to Probit analysis to generate dose mortality regression lines. Effects on the fungus on larval and pupation rates were also recorded.

Dead small hive beetles were collected after treatments and surface-sterilized with Exspor (Alcide Corp., Redmond, Wash.) and 95% ethanol, then placed on water-agar to assess the recovery of the fungus. The agar plates were incubated at 25° C. for 5-10 days, and only beetles that showed fungal growth were considered to have died from infection.

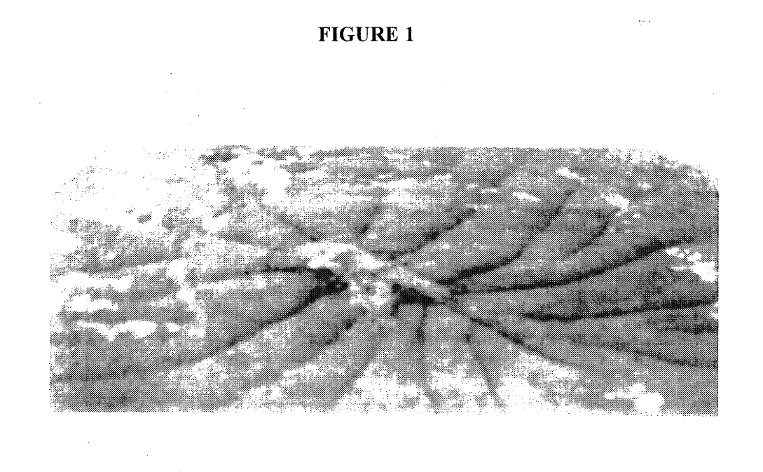

Metarhizum anisopliae was pathogenic to larvae of small hive beetle in soil bioassays. The lethal concentrations estimated to cause 50% cumulative mortality of beetles (LC₅₀) were 7.5×10⁶, and 4.13×10⁶, and 0.02×10⁶ conidia/ml for 7, 14, and 21 days post treatments, respectively. Lethal concentration estimated to cause 90% cumulative mortality of beetles (LC₉₀) were 66.04×10⁶, and 57.68×10⁶, and 4.20×10⁶ conidia/ml for 7, 14, and 21 days post treatments, respectively (Table 2). In addition, 62.5% of larvae initiated pupation by day 8 in lower dose treatments (10⁴ to 10⁷), but died of fungal infection within 14 to 21 days (FIG. 1).

### Example 3

The infectivity of Beauveria bassiana against Aethina tumida. The small hive beetles used in bioassays were collected from infested hives from honey bee colonies maintained at the apiary at FAMU Research Farm, Quincy, Fla. and at Rish Tupelo Apiary Wewahitchka, Fla. The Beauveria bassiana strain was recovered from diseased small hive beetles collected in the field and cultured on fungal media after surface sterilization. The fungal isolate was isolated, identified and subcultured in Petri dishes on Sabouraud maltose agar (Difco, Detroit, Mich.) supplemented with 1% yeast (SMAY), and incubated at 27±1° C., 85% relative humidity, and 13:11 (Light:Dark) h photoperiod. Conidia from 14-19 day-old cultures were harvested with 0.1% Triton X-100, washed once in deionized water by centrifugation at 5,000 rpm for 20 min to concentrate the spores. They were then diluted in distilled water to produce fungal suspensions ranging from 10⁴ to 10¹¹ per ml for bioassays. Twenty to thirty small hive beetles were transferred to glass Petri plates containing a wet Whatman filter paper (Whatman International Ltd, Maidstone, England) and sprayed with 1-ml of conidial suspensions using a Potter Precision Spray Tower (Burkhard Manufacturing, Rickmansworth, England) with 0.7 kg·cm⁻² pressure and a 0.25 mm orifice diameter nozzle. Small hive beetles treated with distilled water only served as controls. Three treated small hive beetle were then transferred to each SOLO (2 mm depth, ¾ filled) laboratory bioassay cup (BIO-SERV, Urbana, Ill.) containing pollen dough substitutes as a food source. Mortality data were compiled and subjected to Probit analysis to generate dose mortality regression lines.

Dead small hive beetles were collected after treatments and surface-sterilized with Exspor (Alcide Corp., Redmond, Wash.) and 95% ethanol, then placed on water-agar to assess the recovery of the fungus. The agar plates were incubated at 25° C. for 5-10 days, and only beetles that showed fungal growth were considered to have died from infection and used in data analysis.

Beauveria bassiana was pathogenic to small hive beetle at temperatures similar to that maintained by honey bees in a colony. Lethal concentration for 50% cumulative mortality of beetles (LC₉₀) was 10.09×10⁸ conidia/ml for larvae and 0.20×10⁸ conidia/ml for adults. (Table 3).

### Example 4

The efficacy of Beauveria bassiana was determined in soil drench bioassays against larvae and pupae small hive beetles using similar bioassay techniques as described in Example 1.

Sterilized soil samples (20 g) were placed inside the SOLO laboratory cups. The soil samples were sprinkled with 2 ml of water; covered and allowed to settle for approximately 30 minutes under a fume cupboard. One ml of each concentration of the fungal spores in triton was then pipetted into each treatment cup. After the fungus was added to the soil, four instar larvae of small hive beetle were transferred into each cup. Deionized water containing 0.02% Silwet L-77 was used as controls for each experiment run. Five concentrations: 10⁴, 10⁵, 10⁶, 10⁷, and 10⁸ conidia per ml were tested and each treatment was replicated three times. The treated beetles were held in an incubator [27±1° C., 85% relative humidity, and 13:11 (Light:Dark) h photoperiod]. Beetle mortality was recorded daily for 21 days. Mortality data were compiled and subjected to analysis to generate dose mortality regression lines. Effects on the fungus on larval and pupation rates were also recorded.

Dead small hive beetles were collected after treatments and surface-sterilized with Exspor (Alcide Corp., Redmond, Wash.) and 95% ethanol, then placed on water-agar to assess the recovery of the fungus. The agar plates were incubated at 25° C. for 5-10 days, and only beetles that showed fungal growth were considered to have died from infection.

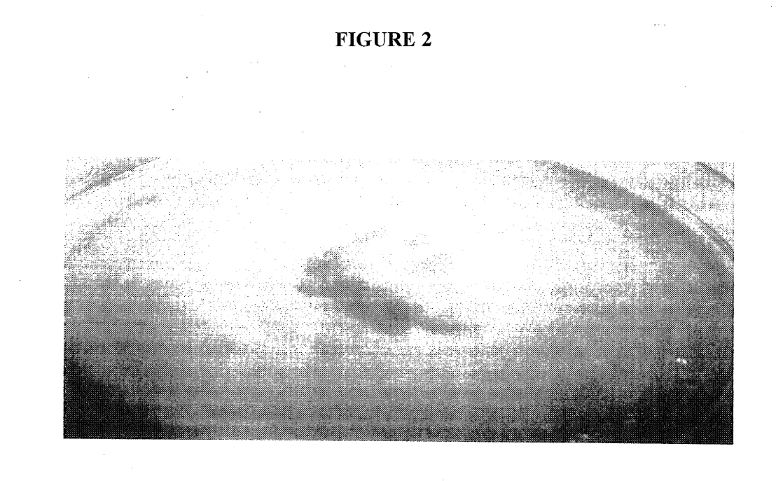

Beauveria bassiana was pathogenic to larvae of small hive beetle in soil bioassays. The lethal concentrations estimated to cause 50% cumulative mortality of beetles (LC₅₀) were 0.39×10⁸, and 0.5×10⁸ conidia/ml for 7, and 14 days post treatments, respectively. Lethal concentration estimated to cause 90% cumulative mortality of beetles (LC₉₀) were 15.492×10⁸, and 20.61×10⁸ conidia/ml for 7, and 14 days post treatments, respectively (Table 4). In addition, 62.5% of larvae initiated pupation by day 8 in lower dose treatments (10⁴ to 10⁷), but died of fungal infection within 14 to 21 days (FIG. 2).

It is understood that the foregoing detailed description is given merely by way of illustration and that modifications and variations may be made therein without departing from the spirit and scope of the invention.

TABLE 1
Pathogenicity of Metarhizium anisopliae against
Small Hive Beetles in Spray Tower Bioassays

| Development | | | LC₅₀^{b} | LC₉₀^{b} |
|---|---|---|---|---|
| stage | na^{a} | Slope ± SE | (95% CI) | (95% CI) |
| Adult | 126 | 0.98 ± 0.42 | 0.10 | 2.73 |
| | | | (0.005-0.19) | (0.15-56.02) |
| Larvae | 120 | 1.65 ± 0.56 | 8.4 | 80.30 |
| | | | (0.16-10.50) | (24.50-362.16) |

^{a}Number of beetles tested
^{b}Concentrations are expressed in × 10⁷ conidia ml⁻¹

TABLE 2
Pathogenicity of Metarhizium anisopliae against
Small Hive Beetles in Soil Bioassays

| | | | | |
|---|---|---|---|---|
| Development | | | LC₅₀^{b} | LC₉₀^{b} |
| stage | na^{a} | Slope ± SE | (95% CI) | (95% CI) |

After 7 days

| | | | | |
|---|---|---|---|---|
| Larvae | 130 | 2.33 ± 0.48 | 7.54 | 66.04 |
| | | | (4.96-12.47) | (30.47-370.25) |

After 14 days

| | | | | |
|---|---|---|---|---|
| Larvae | 130 | 1.57 ± 0.34 | 4.12 | 102.68 |
| | | | (2.19-7.65) | (35.13-1300) |

After 21 days

| | | | | |
|---|---|---|---|---|
| Larvae | 130 | 0.92 ± 0.42 | 0.02 | 4.20 |
| | | | (0.009-0.16) | (1.03-150) |

^{a}Number of beetles tested
^{b}Concentrations are expressed in × 10⁶conidia ml⁻¹

TABLE 3
Pathogenicity of Beauveria bassiana against
Small Hive Beetles in Soil Bioassays

| Development | | | LC₅₀^{b} | LC₉₀^{b} |
|---|---|---|---|---|
| stage | na^{a} | Slope ± SE | (95% CI) | (95% CI) |
| Adult | 75 | 0.82 ± 0.34 | 0.20 | 105.90 |
| | | | (0.05-13.90) | (5.20-2.03)) × 10³ |
| Larvae | 95 | 0.76 ± 0.25 | 10.09 | 777.90 |
| | | | (1.51-40.65) | (14.30-2.96) × 10³ |

^{a}Number of beetles tested
^{b}Concentrations are expressed in × 10⁸ conidia ml⁻¹

TABLE 4
Pathogenicity of Beauveria bassiana against
Small Hive Beetles in Soil Bioassays

| | | | | |
|---|---|---|---|---|
| | | | LC₅₀^{b} | |
| Development stage | na^{a} | Slope ± SE | (95% CI) | LC₉₀^{b} (95% CI) |

After 7 days

| | | | | |
|---|---|---|---|---|
| Larvae | 90 | 0.85 ± 0.30 | 0.39 | 15.49 |
| | | | (0.05-4.66) | (3.05-37.02) |

After 14 days

| | | | | |
|---|---|---|---|---|
| Larvae | 85 | 0.53 ± 0.14 | 0.5 | 20.61 |
| | | | (0.04-3.86) | (7.98-39.26) |

^{a}Number of beetles tested
^{b}Concentrations are expressed in × 10⁸ conidia ml⁻¹

1. A method of controlling small hive beetles in populations of honey bees which comprises contacting said beetles with a composition comprising a fungus selected from the group consisting of Metarhizum anisopliae and Beauveria bassiana.

2. A method of controlling small hive beetles in populations of honey bees which comprises contacting said beetles with a composition comprising Metarhizum anisopliae and isolates thereof.

3. A method of controlling small hive beetles in populations of honey bees which comprises contacting said beetles with a composition comprising Beauveria bassiana and isolates thereof.

4. A method as claimed in claim 1, wherein the adult beetle, the larvae, or the pupae are contacted directed with the composition.

5. A method as claimed in claim 1, wherein the composition is applied to a honey bee hive such that composition is transferred to the small hive beetle upon contact with the fungal spores of the fungus.

6. A method a claims in claim 1, wherein the composition is applied to a honey bee hive such that the composition is transferred to the small hive beetle upon contact with the honey bee hive.

7. A method as claimed in claim 1, wherein the composition is applied to the soil in close proximity to the honey bee hive such that the composition is transferred to the small hive beetle upon contact with the soil.

8. A method as claimed in claim 6, wherein the composition is applied to the hive by spraying, dusting, atomizing, dropping, or baiting.

9. A method as claimed in claim 7, wherein the composition is applied to the soil by spraying, dusting, atomizing, dropping, or mixing.

10. A method as claimed in claim 6, wherein a strip is coated with the composition and the strip is positioned within the honey bee hive.

11. A method as claimed in claim 10, wherein the strip is made from paper, plastic, or a textile.

12. A method as claimed in claim 7, wherein a composition is applied to the soil in a pan and is positioned at the bottom board of the bee hive.

13. A method as claimed in claim 1, wherein the composition comprises an inert carrier.

14. A method as claimed in claim 1, wherein the composition is a powder.

15. A method as claimed in claim 1, wherein the composition is an aqueous suspension.

16. A method as claimed in claim 1, wherein the composition further comprises a feeding supplement selected from the group consisting of pollen, pollen substitutes, sugar, and mixtures thereof.

17. A composition comprising an aqueous suspension of Metarhizum anisopliae and soil.

18. A composition comprising an aqueous suspension of Beauveria bassina and soil

19. A composition according to claim 17 further comprising a feeding supplement selected from the group consisting of pollen, pollen substitutes, sugar, and mixtures thereof.

20. A composition according to claim 18, further comprising a feed supplement selected from the group consisting of pollen, pollen substitutes, sugar and mixtures thereof.
